(19) United States
(12) Patent Application Publication
(10) Pub. No.: US 2016/0180658 A1
(43) Pub. Date: Jun. 23, 2016

(54) APPARATUS AND METHOD FOR ADAPTIVE NOTIFICATIONS

(71) Applicant: SYMBOL TECHNOLOGIES, INC., Lincolnshire, IL (US)

(72) Inventor: DAVID DEGRASSI, MISSISSAUGA (CA)

(21) Appl. No.: 14/576,825

(22) Filed: Dec. 19, 2014

(51) Int. Cl. G08B 3/10

(52) U.S. Cl. CPC G08B 3/10

(57) ABSTRACT

A method and apparatus for outputting an audio notification at a data capture device is provided. The data capture device comprises a processor, an audio input apparatus and a speaker. In operation a detected sound representative of ambient sounds is detected at the audio input apparatus. The processor modifies the audio notification based on the detected sound. The modification includes at least one of modifying one or more frequency components of the audio notification and modifying a tone sequence of the audio notification. The modified notification is outputted at the audio output apparatus. The processor can also determine whether the audio notification can be modified to compensate for interference from the detected sound and perform the modifying when the determination is affirmative.

### BACKGROUND OF THE INVENTION

Data capture devices such as bar code scanners facilitate information retrieval from objects and locations in a convenient manner. For example, a bar code scanner may be used to read bar codes on prepackaged items at a point of sale. Accordingly, a checkout clerk may identify a product being purchased and its associated price by scanning a bar code and eliminating the need to type the information manually, speeding up the checkout process significantly.

Data capture is typically performed in a routine manner, repeating data scans in quick succession. For example, at a checkout, a purchased item is scanned within a matter of seconds to capture its identification and price, and this scan process is repeated for each item purchased. Various audio notifications are provided to indicate the status of a data capture process. For example, the success or failure of a data capture operation can be communicated with an audio notification, providing different notification for each outcome. Accordingly, being able to quickly identify notifications is important for rapid scanning. However, operating environments of data capture devices are such that there is typically ambient noise interfering with and thus obfuscating the audio notifications. In addition, many data capture devices typically operate within close proximity of each other, resulting in confusion as to where an audio notification came from. Accordingly, there is a need for an improved provision of audio notifications on a data capture device.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a data capture device in accordance with some embodiments.

FIG. 2 is a perspective view of the data capture device of FIG. 1 in accordance with some embodiments.

FIG. 3 is a flowchart of a method of providing adaptive audio notifications in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

A method and apparatus for outputting an audio notification at a data capture device is provided. The data capture device comprises a processor, an audio input apparatus and a speaker. In operation a detected sound representative of ambient sounds is detected at the audio input apparatus. The processor modifies the audio notification based on the detected sound. The modification includes at least one of modifying one or more frequency components of the audio notification and modifying a tone sequence of the audio notification. The modified notification is outputted at the audio output apparatus. The processor can also determine whether the audio notification can be modified to compensate for interference from the detected sound and perform the modifying when the determination is affirmative.

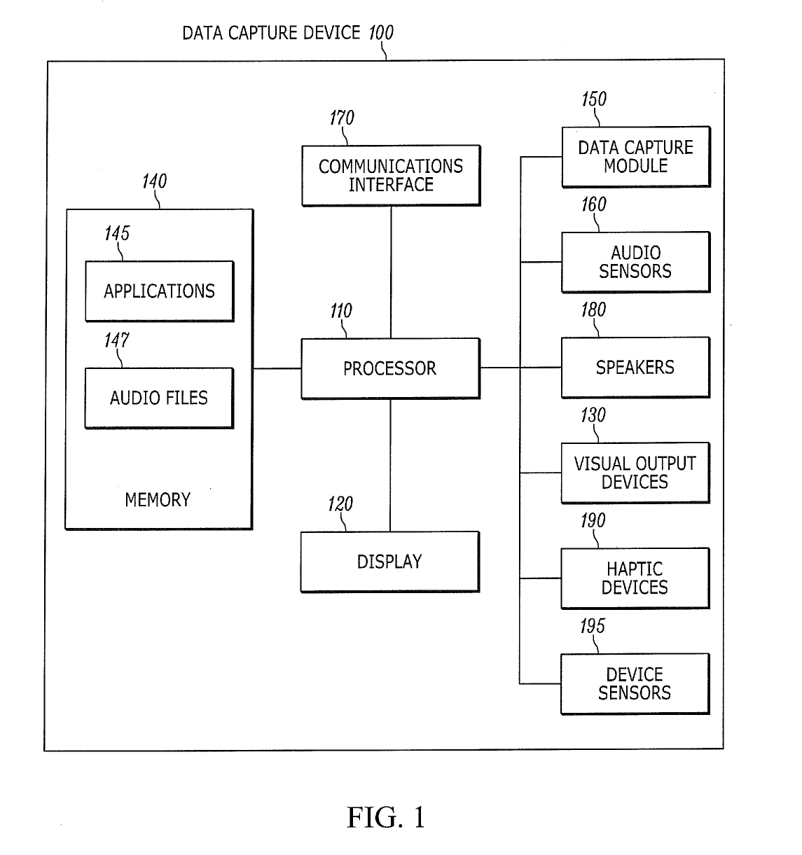

FIG. 1 is a block diagram of a data capture device 100 in which methods and components required for providing adaptive notifications is implemented in accordance with the embodiments. The data capture device 100 may take the form of, but is not limited to, handheld devices such as a smart phone, a bar code scanner, optical code reader and the like, a data capture terminal connected to a handheld device, desktop, laptop or notebook computer, an automated teller machine, a kiosk, a vending machine, a payment machine, facsimile machine, a point of sale device, a ring scanner and the like.

The data capture device 100 comprises a processor 110, a display 120, one or more visual output devices 130, a memory 140, a data capture module 150, one or more audio sensors 160, a communications interface 170, one or more speakers 180, and one or more haptic devices 190. The processor 110 runs or executes operating instructions or applications 145 that are stored in the memory 140 to perform various functions for the data capture device 100 and to process data. The processor 110 includes one or more microprocessors, microcontrollers, digital signal processors (DSP), state machines, logic circuitry, or any device or devices that process information based on operational or programming instructions stored in the memory 140. In accordance with the embodiments, the processor 110 processes various functions and data associated with carrying out the provision of adaptive notification.

The display 120 may be realized as an electronic display configured to graphically display information and/or content under the control of the processor 110. Depending on the implementation of the embodiment, the display 120 may be realized as a liquid crystal display (LCD), a touch-sensitive display, a cathode ray tube (CRT), a light emitting diode (LED) display, an organic light emitting diode (OLED) display, a plasma display, a projection display, or another suitable electronic display. The display 120 may provide a user interface between the data capture device 100 and a user.

In some implementations, the display 120 includes a touch sensor. The touch sensor can provide an input interface that can complement an output interface, as provided by the display 120. The touch sensor may have a touch-sensitive surface, sensor, or set of sensors that accepts input from the user based on haptic and/or tactile contact. The touch sensor may be operated on by an input item (such as a finger of a user or other input device such as a stylus, including passive and active) to provide touch sensitive inputs to the data capture device 100. In accordance with some embodiments, the display 120 has a virtual keypad or keyboard that comprises a plurality of graphical keys or buttons arranged in a predetermined layout (for example, QWERTY keyboard or numeric/alpha numeric keypads) to allow the user to tap or touch the keys in a sequence to provide inputs to the data capture device 100.

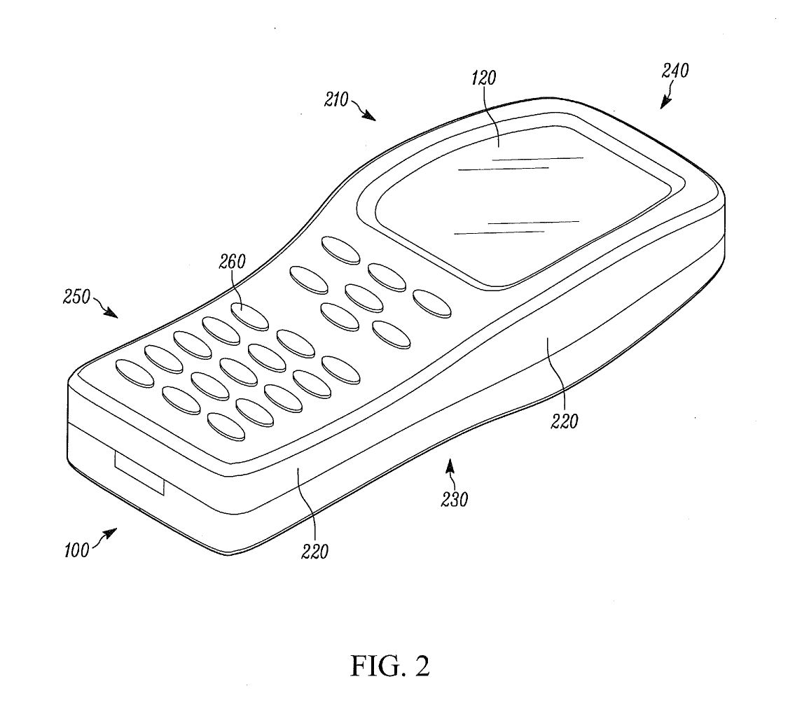

The visual output devices 130 can be realized as any devices configured to provide visual notifications in the form of visual output such as light or a laser beam under the control of the processor 110. Depending on the implementation of the embodiment, the visual output devices 130 may be realized as light emitting diodes (LEDs), organic light emitting diodes (OLEDs) or other suitable mechanisms for providing a visual output. The visual output devices 130 may be configured to provide a constant color output, variable color output, where the color outputted may be varied under the control of the processor 110, constant brightness output and variable brightness output where the brightness of the visual output may be varied under the control of the processor 110. In implementations where more than one visual output device 130 is provided, they may be located on various locations on the data capture device 130. For example, referring to FIG. 2 where a perspective view of the example data capture device 100 is shown, one or more of the visual output devices 130 may be located on a top surface 210. Alternatively, or in addition, one or more of the visual output devices 130 may be located on a side surface 220 or a bottom surface 230. In variations, the visual output devices may be placed closer to an upper end 240 or a lower end 250 of the data capture device 100, or both. The location(s) of the visual output devices 130 may be chosen based on intended use of the data capture device 100 as well as the locations of other components of the data capture device 100 such as the display 120, keyboard 260 and the like.

The memory 140 can be any storage device, or combination of storage devices configured to store digital information. The memory 140 can be an IC (integrated circuit) memory chip containing any form of RAM (random-access memory) or ROM (read-only memory), a CD-RW (compact disk with read write), a hard disk drive, a DVD-RW (digital versatile disc with read write), a flash memory card, external subscriber identity module (SIM) card or any other non-transitory medium for storing digital information. The memory 140 is configured to maintain applications 145. The applications 145 include various software and/or firmware programs and instructions necessary for the operation of the data capture device 100 as well as software and/or firmware programs and instructions (e.g. warehouse applications, email applications etc.) that address specific requirements of the operator. The memory 140 is also configured to maintain data files such as audio files 147, based on which audio output can be generated by the data capture device 100.

The data capture module 150 includes one or more data sensors for capturing data from various data sources. A data sensor may be an optical sensor such as a charge-coupled device (CCD) sensor, a laser scanner and the like, that may capture data from optical data sources such as bar codes, quick response (QR) codes and video response (VR) codes and other similar optical data sources. Data sensors may also include electromagnetic sensors such as near field communication (NFC) sensors and radio frequency identification (RFID) readers that may capture data from electromagnetic data sources such as from RFID tags and NFC tags and the like.

The data capture module 150 may also include additional components to aid with its operation such as lasers for scanning optical data, optics for directing light to image sensors and antennae for aiding data reception by electromagnetic readers. To capture optical data, the optics of the data capture module 150 may be pointed at the data source, such as a bar code, at an appropriate distance. To capture RFID or NFC data, antennae associated with the RFID reader or NFC sensor are brought within a prescribed range of the item containing the RFID or NFC tag. In accordance with some embodiments, the data capture device 100 may include multiple data capture modules 150, each module including one or more data sensors.

The audio sensors 160 detect sound input at the data capture device 100 under the control of the processor 110. For example, one or more microphones may detect ambient sound and/or operator voice. The detected sound may be in the form of a sound sequence comprising a sequence of sounds or tones detected for a time duration. The sound sequence may have a frequency component and a magnitude component. The frequency component typically indicates one or more frequencies that comprise the detected sound and the magnitude component is typically an indicator of relative magnitude of the detected sound. In some implementations, the magnitude component may also indicate the relative magnitude of one or more frequency components of the detected sound.

Communications interface 170 provides the data capture device 100 with the ability to form a communications connection with networks and other devices. The connection may be wired or wireless. In accordance with some embodiments, it will be appreciated that the connection may utilize a wireless communication system, a wired communication system, a broadcast communication system, or any other equivalent communication system. For example, the communication system may function utilizing any wireless radio frequency channel, for example, a one or two-way messaging channel, a mobile cellular telephone channel, or a mobile radio channel. Similarly, it will be appreciated that the communication system may function utilizing other types of communication channels such as Institute of Electrical and Electronics Engineers (IEEE) 802.11, IEEE 802.16 and/or Bluetooth channels. Further, it will be appreciated that the communication system may function utilizing a wireline communication channel such as a local area network (LAN) or a wide area network (WAN) or a combination of both. The LAN, for example, may employ any one of a number of networking protocols, such as TCP/IP (Transmission Control Protocol/Internet Protocol), AppleTalk™, IPX/SPX (Inter-Packet Exchange/Sequential Packet Exchange), Net BIOS (Network Basic Input Output System) or any other packet structures to enable the communication among the devices and/or chargers. The WAN, for example, may use a physical network media such as X.25, Frame Relay, ISDN, Modem dial-up or other media to connect devices or other local area networks. In the following description, the term “communication system” or “connection” refers to any of the systems mentioned above or an equivalent. Embodiments may be advantageously implemented to perform the provision of adaptive notifications on the data capture device 100. Embodiments may be implemented in any electronic device performing data capture.

The speakers 180 provide audio notifications under the control of the processor 110. One or more speakers 180 may be located across the data capture device 100. The speakers 180 may be realized as any electro mechanical speakers such as piezoelectric speakers. An audio notification may be in the form of a sound sequence. The sound sequence may comprise a single continuous tone or a sequence of various tones. The frequency, sequence, duration and magnitude of the tones may vary under the control of the processor 110. In some variations, an audio notification may be generated under the control of the processor 110 based on an audio notification indicator stored in memory 140. For example, the sound sequence may be generated based on sound files 147 maintained in memory 140. The sound files 147 may indicate a sound sequence to be provided at the speakers 180 and may be stored in accordance with audio file formats such as WAV, AIFF and the like. In variations, the sound sequence indicated by a sound file 147 may be modified prior to its provision to the speakers 180, altering one or more of its attributes such as the sequence, the frequency, the duration and/or the magnitude of the tones indicated by the sound file 147.

The haptic devices 190 are configured to provide haptic notifications under the control of the processor 110. The haptic devices 190 may be realized as one or more apparatuses, such as motors, that can provide a tactile feedback through the data capture device 100. The haptic notifications can have a frequency, a magnitude and a duration component.

The device sensors 195 are configured to detect various attributes of the data capture device 100 such as its position and orientation and movement. Some device sensors 195 can detect various forces applied to the data capture device 100. For example, some device sensors 195, such as motion sensors including accelerometers and gyroscopes, can detect acceleration (and thus position changes) and changes in orientation respectively. Other device sensors 195, such as pressure sensors, can detect pressure applied to the housing or display 120 of the data capture device 100, and accordingly allow a determination that the capture device 100 is being held or gripped. A force sensor can be fabricated using any suitable force sensing technology. Device sensors 195 can include further sensors such as magnetometers, and the like. Additional device sensors 195 such as cameras and proximity sensors can also detect device position and orientation information relative to other objects around the data capture device such as tables and users, for example. Location determination sensors such as GPS and cell tower triangulation mechanisms can also detect information regarding a data capture device 100's position.

In some embodiments, the notifications provided by the data capture device 100 may be modified based on the sounds as detected by the audio sensors 160. For example, in some variations, prior to providing an audio notification, the detected sound can be analyzed to identify its frequency and magnitude components. Based on the frequency and the magnitude components of the detected sound, the detected sound may be classified as a source of potential interference for the audio notification to be provided. When the detected sound is classified as a source of potential interference for the audio notification, a determination can be made as to whether the audio notification can be modified in such a manner so as to reduce the interference. When the determination is affirmative, the frequency components, the duration, the tone sequence and/or the magnitude components of the audio notification may be modified to compensate for the potential interference. As an example, when the detected sound indicates an ambient noise with a high volume low frequency component, the frequency of the audio notification can be shifted to a higher frequency range to make the audio notification easier to distinguish from the ambient noise. The modification to the audio notification can be accomplished in various ways. For example, the content of the audio notification to be generated by the processor 110 based on an audio notification indicator such as an audio file 147, can be altered prior to processing by the processor 110 to compensate for the potential interference. Alternatively, different versions of the audio file may be stored, each to be played back under different ambient sound conditions, for example.

In further variations, the data capture device 100 may monitor the detected sound for a match to the actual audio notifications that are stored in the memory 140 as audio files 147. If one of the stored audio notifications matches a portion of the detected sound, that audio notification may be altered by changing the frequency, the duration, the sequence and/or the magnitude of the audio notification prior to playing it back. It yet further variations, the recognized audio notification may be substituted by another audio notification that is different from the recognized one.

When the determination is negative, indicating that the audio notification cannot be compensated in a manner which can substantially compensate for the audio notification, alternative modalities of notifications may be provided in place of or in addition to the audio notification. The audio notification may nevertheless be modified in such circumstances. The additional or alternative modalities can include visual notifications and haptic notifications.

In the case of the visual notifications, a position, an orientation and an operational history of the data capture device may be determined based on the device sensors. Based on the position, orientation and operational history of the data capture device, one or more specific visual notification devices 130 may be chosen to provide the visual notification, in order to improve the noticeability of the visual notification. For example, the position and orientation of the device may be used to determine which visual notification devices 130 are visible to a user of the device. As an example, when it is determined that the data capture device is lying on a surface with the top surface of the data capture device pointing down, the visual notification devices 130 that are located on the bottom surface 230 of the data capture device 100 may be chosen to provide an audio notification. When, on the other hand, the device is determined to be in use, based on an operational history of the device, such as a data scan performed very recently, and a grip sensor indicating that the device is being held, the display 120 may be used to provide the visual notification, along with the visual notification sensors 130 that are on the top surface 220 of the data capture device 100. In some variations, the location on the display where a notification is provided may be also adjusted based on a position and orientation of the device. In further variations, other attributes of the visual notification can also be modified such as color, color sequence, pulsing of the modification and brightness. In other variations, visual sensors on the data capture device can be used to detect the ambient visual conditions and further alter the visual notifications based on the visual sensor input.

In the case of the haptic notifications, a frequency, a magnitude and a duration of the haptic notification may be adjusted based on the detected sound, operational history of the data capture device 100 and indications obtained from the device sensors 195. For example, when the device is lying motionless on a surface, the magnitude and duration may be increased, in comparison with when the data capture device 100 is determined to be held by an operator. Alternatively, when a user is wearing a glove, a higher magnitude vibration may be selected. In some variations, different haptic notification settings may be maintained in the memory 140, and made available for selection by the user

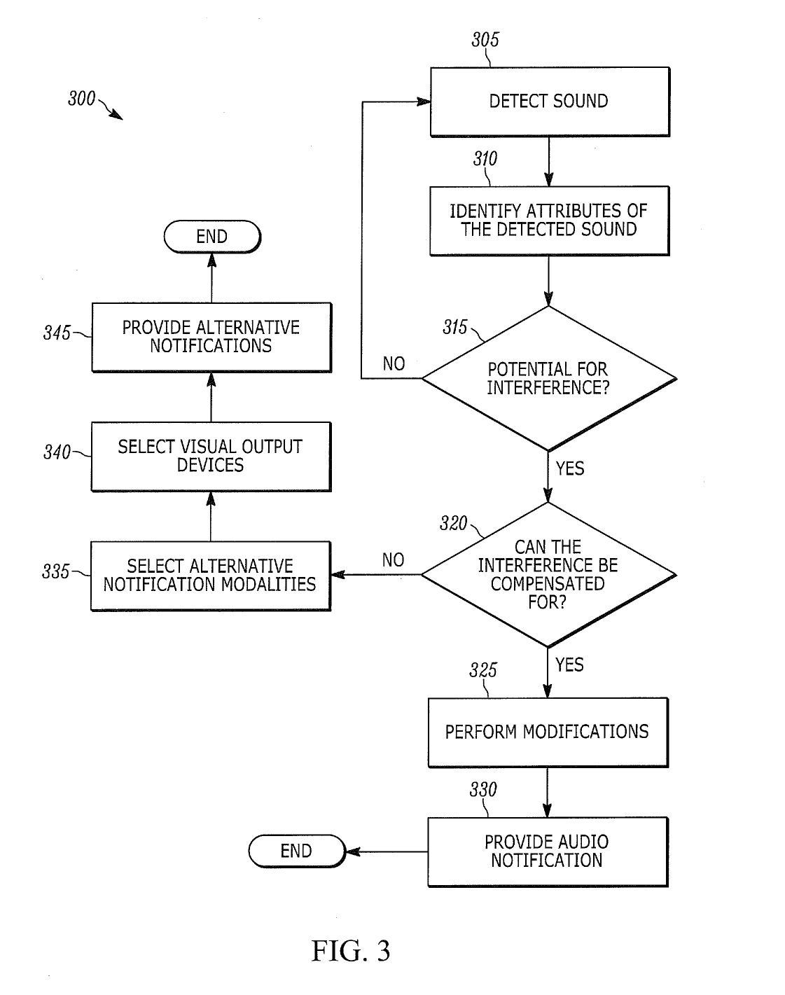

FIG. 3 represents a flowchart of a method 300 for providing adaptive notifications at the data capture device 100 of FIG. 1 in accordance with some embodiments. As shown in FIG. 3, the method 300 begins by detecting a detected sound at block 305. The detected sound is detected by the audio sensors 160 and communicated to the processor 110 for analysis in the form of a sound sequence. The detected sound typically is an indicator of ambient sounds and/or operator voice, for example. Continuing with the method 300 at block 310, the detected sound is processed. The processing is performed by the processor 110 to identify different attributes of the detected sound such as the range of frequencies present, sound magnitude or magnitudes, tone sequence and duration.

At 315 the detected sound is classified as either a source of potential interference for the audio notification to be provided or not. The classification can be based on one or more factors such as the presence of certain predetermined frequencies, the magnitude of the detected sound and/or of the detected sound at some or all of the range of frequencies present, the particular sequence of sounds or tones present, the matching of the detected sound to an audio notification to be provided at the data capture device 100, and the like.

When the classification is that the detected sound is not potential for interference, and can thus be ignored, the method continues back to block 305 to continue to detect further sounds. When, on the other hand, the detected sound is classified as a potential for causing interference, and thus is to be addressed, the method moves to block 320.

At block 320, a determination is made as to whether the potential interference can be compensated for through modifications to the audio notification to be provided. When potential interferences can be compensated for based on modifications to the audio notification, at block 325, one or more modifications are performed. The modifications can involve one or more of adjusting the overall frequency of the notification, adjusting certain frequency components of the notification, changing the sequence of sounds or tones, changing the duration and/or frequency of each sound or tone in the sequence, modifying the magnitude and thus volume of one or more portions of the audio notification or its frequency components and replacing the current audio notification with a different audio notification. Once the modifications are performed, the modified audio notification is provided at one or more speakers 180 at block 330, subsequent to which the method ends.

When a determination is made at block 320 that modifications to the audio notification are not sufficiently effective at compensating for the potential interference, alternative modalities may be selected at block 335 in which to provide the notification. The alternative modalities may include haptic notifications and/or visual notifications. Where visual notifications are to be provided, the particular set of visual notification devices 130 may be selected at block 340, through which the visual notification can be provided. The selection of the particular set of visual output devices 130 can be determined on the basis of the position and orientation as well as the operational history of the data capture device. For example, the visual output devices, determined to be closest to an operator based on the device sensors 195 may be used to provide the visual notifications. Once the visual output devices 130, and in some variations potentially the display 120, are selected, the alternative notifications are provided at block 345, subsequent to which the method 300 ends.

In some embodiments, the method 300 can be performed prior to the provision of each audio notification. In variations, the method can be performed continuously. In further variations, the block 320 may be omitted. Accordingly, once modifications are performed, the method can advance to block 335 to provide additional notifications using alternative modalities as described below. Thus, in these variations, once a determination is made that there is potential for interference, the audio notifications are modified, and the modified audio notifications are always presented along with alternative modality notifications. In further variations, an affirmative input can be obtained prior to performing any modifications to the audio notification or providing alternative or additional modality input, the input indicating the approval of such modifications or alternatives.

In the foregoing specification, specific embodiments have been described. However, one of ordinary skill in the art appreciates that various modifications and changes may be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment may be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method of providing an audio notification at a data capture device comprising a processor, an audio input apparatus and a speaker, the method comprising:
detecting, at the audio input apparatus, a detected sound representative of ambient sounds;
modifying, by the processor, the audio notification based on the detected sound, the modification including at least one of modifying one or more frequency components of the audio notification and modifying a tone sequence of the audio notification; and
providing, at the speaker, the modified notification.

2. The method of claim 1 further comprising:
determining, by the processor, whether the audio notification can be modified to compensate for interference from the detected sound; and
performing the modifying when the determination is affirmative.

3. The method of claim 2 further comprising:
classifying, by the processor, the detected sound as a potential source of interference based on at least one of: a presence of certain predetermined frequencies, a magnitude of the detected sound, a magnitude of the detected sound at some or all of a range of frequencies present in the detected sound, a predetermined sequence of tones present in the detected sound and a matching of a portion of the detected sound to the audio notification,
wherein the determining is performed when the detected sound is classified as a potential source of interference.

4. The method of claim 1, wherein the modification further includes one of adjusting an overall frequency of the audio notification, adjusting one or more frequency components of the audio notification, adjusting a duration of the audio notification, adjusting a frequency of each tone in the tone sequence of the audio notification, adjusting a magnitude of one or more portions of the frequency components of the audio notification and replacing the audio notification with a different audio notification.

5. The method of claim 1 wherein the audio notification is based on a first audio file and modifying the tone sequence involves basing the notification on a second audio file different from the first audio file.

6. The method of claim 5 further comprising:
determining, by the processor, that the detected sound includes a portion matching the audio notification;
performing the modification when the determining is affirmative, wherein the modification is the modifying of the tone sequence.

7. The method of claim 6 further comprising:
classifying, by the processor, the detected sound as one of a plurality of predetermined ambient sound conditions,
wherein the second audio file is selected based on the classification of the detected sound.

8. The method of claim 1 further comprising obtaining an affirmative input from an input device of the data capture device prior to modifying the audio notification.

9. The method of claim 2 wherein the data capture device further comprises a haptic device further comprising:
when the determination is negative, providing, at the haptic device, a haptic notification.

10. The method of claim 2 wherein the data capture device further comprises a plurality of visual output devices, the method further comprising:
when the determination is negative, providing, at the plurality of visual output devices, a visual notification.

11. The method of claim 10 wherein the visual notification is provided in place of the audio notification.

12. The method of claim 10 further comprising:
determining, by the processor, at least one of an orientation, a location and an operational history of the data capture device;
selecting a visual output device from the plurality of visual output devices, based on at least one of the orientation, the location and the operational history of the data capture device; and
providing the visual notification at the selected visual output device.

13. The method of claim 11 wherein the plurality of visual output devices includes a display.

14. The method of claim 13 wherein when the selected visual output device is the display, the method further comprising:
providing the visual notification at the display, at a location and a size, the location and the size based on at least one of the orientation, the location and the operational history of the data capture device.

15. The method of claim 12 further comprising selecting at least one of a brightness, a pulse frequency, a color and a color sequence of the visual notification based on at least one of the orientation, the location and the operational history of the data capture device.

16. A data capture device comprising:
a processor;
an audio input apparatus and a speaker connected to the processor, the processor operating to:
receive, from the audio input apparatus, a detected sound representative of ambient sounds;
modify an audio notification based on the detected sound, the modification including at least one of modifying one or more frequency components of the audio notification and modifying a tone sequence of the audio notification; and
providing, by controlling the speaker, the modified notification.

17. The data capture device of claim 16, the processor further operating to:
determine whether the audio notification can be modified to compensate for interference from the detected sound; and
perform the modifying when the determination is affirmative.

18. The data capture device of claim 17, the processor further operating to:
classify the detected sound as a potential source of interference based on at least one of: a presence of certain predetermined frequencies, a magnitude of the detected sound, a magnitude of the detected sound at some or all of a range of frequencies present in the detected sound, a predetermined sequence of tones present in the detected sound and a matching of a portion of the detected sound to the audio notification,
wherein the determining is performed when the detected sound is classified as a potential source of interference.
The data capture device of claim 17 further comprising a plurality of visual output devices, the processor further operating to:
when the determination is negative, control the plurality of visual output devices to provide a visual notification.

19. The data capture device of claim 19, the processor further operating to:
determine at least one of an orientation, a location and an operational history of the data capture device;
select a visual output device from the plurality of visual output devices, based on at least one of the orientation, the location and the operational history of the data capture device; and
control the selected visual output device to provide the visual notification.
